(19) United States
(12) Patent Application Publication
(10) Pub. No.: US 2009/0174265 A1
(43) Pub. Date: Jul. 9, 2009

(54) APPARATUS FOR CONTROLLING THE SWITCHING ON/OFF OF A POWER UNIT

(75) Inventor: Luigi Gozzi, Colle Val D'elsa - Siena (IT)

Correspondence Address: YOUNG & THOMPSON, 209 Madison Street, Suite 500, ALEXANDRIA, VA, 22314, US

(73) Assignee: PRAMAC S.P.A., Casole D'elsa - Siena (IT)

(21) Appl. No.: 12/299,425

(22) PCT Filed: May 30, 2007
(86) PCT No.: PCT/IB2007/001504

§ 371 Date: Nov. 3, 2008

(30) Foreign Application Priority Data
Jun. 22, 2006 (IT) FI2006A000157

(51) Int. Cl. H02B 1/24; F02B 63/04

(52) U.S. Cl. 307/131; 290/1 R

(57) ABSTRACT

Automatic apparatus for controlling the switching on/off of a power unit by monitoring the lines powered therefrom.

### TECHNICAL FIELD

The object of the present invention is an apparatus for controlling the switching on/off of a power unit for supplying power to users connected via a load line.

### BACKGROUND ART

It is known that power units, to be referred hereinafter as GEs, are able to operate in either no-stop or emergency mode, depending on whether their use has to meet a continuous or discontinuous demand of electrical energy.

In particular, in the case of using GEs in building yards, the mode of use is necessarily no-stop, as the supplied facilities are building machines such as cranes, hoists, pneumatic hammers, air compressors, hydrocleaners or, anyway, machines with various electrical applications which can/must operate many times, for more or less extended periods, during a single work cycle.

In these applications, the power units of known type are generally made up of an engine associated with an electric generator and are usually utilized for transforming a mechanical energy, produced by the engine, into electric energy through the electric generator being coupled therewith.

The GEs may have the electric generator connected in single-phase and three-phase configurations, with output voltages generally ranging from 220 and 380 Volts in alternate current, and are able to deliver several levels of power, from the minimum level of “small” GEs for domestic use, about 3.3 kVA, to the maximum one delivers by “big” units for industrial use and able to reach values in excess of 2500 kVA.

The above mentioned GEs, however, have some drawbacks.

A first drawback is due to the fact that even in the absence of energy demand by the users, in cases of no-stop applications such as in active construction sites, the operating machines are anyway always powered and potentially attivable also during inoperative periods, a condition this which, in addition to causing a significant consumption of fuel useless to the operational activity of the building yard, and generating noise and emission of relevant amounts of discharge gas, it is likely to create conditions of poor safety for the operators working in the building yard.

Also known are GEs characterized by being fed, besides an engine, also by a set of buffer batteries which are normally charged by the same engine and, via a transformer of direct-to-alternate current (inverter), provide the power to the concerned users.

However, also this type of GEs is not without drawbacks.

A first drawback is given by the fact that if, at any time, the engine does not feed the electric generator, the latter does not switch off since it is fed directly by the buffer batteries.

These batteries, however, not having an unlimited charge time, tend to run down. For this reason, if the user does not intervene with other types of supplies, or if the engine is not restarted before the batteries run down completely, a black-out of the system is unavoidable.

A further drawback of the electric generators of known type is that, at the end of stop periods, prior to the subsequent utilization, it always necessary to restart the generator manually, and this even if the generator cabin is far away from the machines or in areas of limited access.

### DISCLOSURE OF THE INVENTION

The object of the present invention is to overcome the above described drawbacks by providing an automatic system for controlling the switching on/off of a power unit which, by monitoring the lines powered therefrom, allows using the same power unit independently of operators' interventions and, at the same time, to make the supplied facilities much safer for the operators themselves.

A further object of the present invention is to provide a control system allowing the work of GEs to be optimized over the actual periods of use of the produced energy, thereby reducing consumptions, acoustic emissions, discharge gas and running costs as well.

These and further objects, which will be apparent from the description that follows, are achieved, according to the present invention, by a system for controlling the switching on/off of a power unit having the structural and functional characteristics set forth in the appended claims, further embodiments thereof being disclosed in the corresponding dependent claims.

The invention is illustrated herebelow in greater details with reference to the attached drawings which show an exemplary and not limiting embodiment thereof. In the drawings:

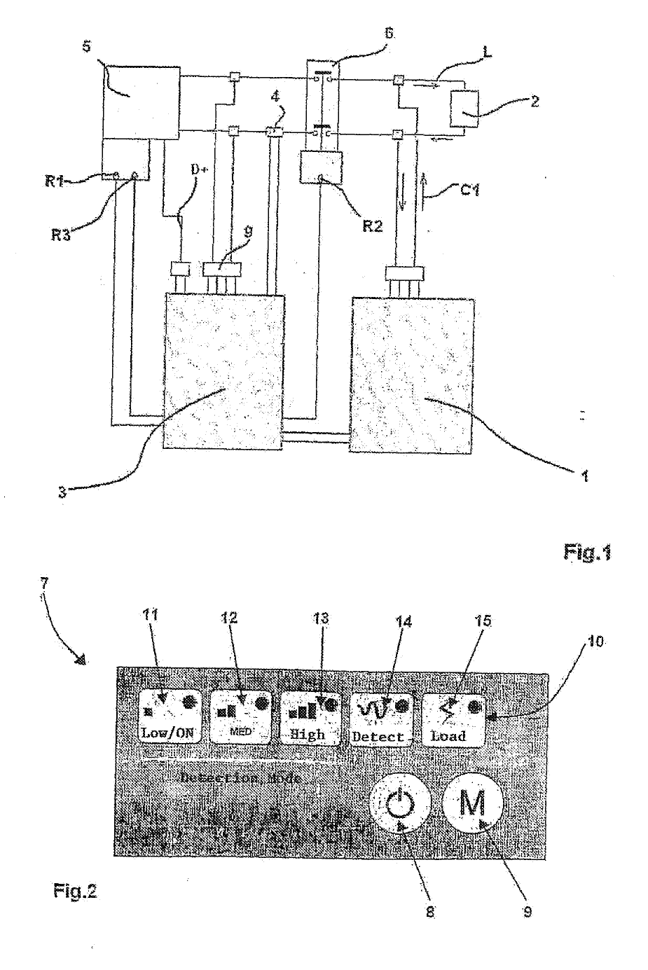

FIG. 1 is a schematic diagram of a control apparatus, according to the present invention, applied to a power unit; and

FIG. 2 shows an embodiment of an interface for the operation and control of the apparatus of FIG. 1.

With reference to FIG. 1, the system for controlling the switching on/off of a power unit 5 for supplying power to users 2 connected to a load line L, comprises: a first monitoring unit 3 for the switching on/off of the power unit 5, a line disconnector 6 applied to the line L and operated by the first monitoring unit 3 via a relay R2 movable between an opening position and a closing position of line L.

The apparatus also comprises a second monitoring unit 1 connected with the first monitoring unit 3 to monitor any request of energy to the GE 5 by the users 2, by means of the flow on line L of an eddy current C1 downstream of the disconnector 6 and to measure a variation of impedance on the line L following any demand of energy, and one or more current detectors 4 connected to the line L upstream of disconnector 6 for continually monitoring the demand of energy once the GE 5 is started and has begun to supply power to the users 2.

These detectors 4 are connected to the first monitoring unit 3 of the GE 5, in single-phase or three-phase configuration, to switch the latter off in the absence of any request of energy for an uninterrupted preset time T1, and are preferably current transformers.

Advantageously, the reading of the current detectors 4 can take place in parallel with the reading of other current deviation devices (“shunts”), these devices being electrical resistances which deviate onto themselves a more or less relevant portion of current flowing over the line L and over the current detectors 4 to which they are connected in parallel.

Preferably, the GE 5 is a generator coupled to a diesel engine, for example, having the following characteristics:
three-phase systems (operating range of 233-480 V);
single-phase systems (operating range of 110-240 V);
frequency of 50 and 60 Hz.

The generator may also comprise: a spark plugs' pre-heating system monitored by the first monitoring unit 3 via a first timed relay R1 to which an acoustic/visual warning means can be linked in parallel to warn about the imminent start of the generator, at least one device for protecting the generator, and a pilot relay R3 for piloting the switching on/off of the power unit 5.

The control system according to the present invention can be powered at 12 or 24 V and comprises at least the above cited relays (R1, R2, R3) which are able to pilot signals at 110-230 V in alternate current, or at 12-24 V in direct current

The table that follows indicates the state of relays R2, R3 during the operation of the generator when the control system is started (ON) and stopped (OFF).

TABLE 1

| | |
|---|---|
| ON | OFF |

| | | | | |
|---|---|---|---|---|
| Phase | R2 | R3 | R2 | R3 |
| OFF | off | Off | off | off |
| START | off | On | off | off |

| | | |
|---|---|---|
| time | 3-5 sec | Off |

| | | | | |
|---|---|---|---|---|
| RUN | on | On | off | off |
| STOP | off | Off | off | off |

| | | |
|---|---|---|
| time | 20 sec | Off |

| | | | | |
|---|---|---|---|---|
| OFF | off | off | off | off |

Table 2 indicates the system's logics of GE control during the start thereof.

In this table, there is indicated the signal from the battery charger of motor D+ which, if present, is interpreted by the control system as a warning of “engine in operation” and, in conjunction with the presence of a tension downstream of line's disconnector 6, provides for a double guarantee over the perfect operating state of GE.

In the absence of one of the two signals D+ or of tension downstream of disconnector 6, the control system is disabled for precaution.

TABLE 2

| | Tension downstream of | |
|---|---|---|
| D+ | disconnector | Control system state |
| Present | Present | RUN |
| Present | Absent | Disabled |
| Absent | Present | Disabled |
| Absent | Absent | OFF |

The operation of the system for controlling the switching on/off of GE 5, according to the present invention, can be identified by two different conditions of use: with the GE 5 in operation and with the GE 5 out of operation.

In the first condition of use, with the GE 5 in operation, in case of prolonged periods of operation of the GE 5 during which the users 2 draw no energy, the control unit 3 automatically switches the GE 5 off by setting it for subsequent starting in case of energy demand by the users 2.

The control of users 2's energy demand takes place by means of the external current detectors 4, preferably current transformers, whose dimension is a function of the power and type (single-phase or three-phase) of GE 5, located in the portion of line L upstream of the disconnector 6 and connected to the unit 3 to which they continually transmit the presence if any of energy demand during the time T1 in which the GE 5 does not deliver any power to line L, the unit 3 continually monitoring this condition and causing the switching off of the same generator as necessary.

In the second condition of use, after the GE 5 has been switched off, the portion of line L downstream of disconnector 6 is monitored by the second monitoring unit 1 which detects the variations of impedance due to any demand of power by the users 2. If a variation of impedance takes place on this portion of line L, and the disconnector 6 is in open condition, the unit 1 delivers a signal of switching-on to unit 3 which, as a first action, activates the relay R1 of preheating/acoustic indicator, then starts the power unit 5 and, only after a predetermined time T2, closes the disconnector 6 to habilitate the supply of power to the users 2.

A further aspect of the present invention comprises an interface for the operation and control of an apparatus like the one previously described.

With reference in particular to FIG. 2, a front panel 7 is shown through which the user can operate and control the apparatus, in particular the GE 5, connected thereto.

The specific, but not limiting embodiment of the front panel 7 being shown, comprises at least a first on/off key 8 and a key for access to a menu 9.

Advantageously, the panel 7 comprises also a plurality of LEDs 10 for indicating the operating state of GE 5.

LEDs 11, 12, 13 indicate the sensibility preset for the control system, that is, the lowest load value which enables the GE 5 to be switched on or off.

In particular, advantageously, the levels of sensibility can be three:
minimum sensibility: comprises impedance values ranging from 5 to 50 Ohm with default value of 20 Ohm;
medium sensibility: comprises impedance values ranging from 60 to 300 Ohm with default value of 80 Ohm; and
maximum sensibility: comprises impedance values ranging from 350 to 2000 Ohm with default value of 500 Ohm.

LED 14 indicates, instead, the presence or absence of a load higher than the preset sensibility value applied to GE 5.

LED 15, when lit, indicates that the GE 5 is connected to a load for the supply thereof.

The user, by interacting with the menu through the respective key 9, is able to set several operation parameters among which, for example: level of sensibility, impedance of the load applied to GE 5, time of self-switching off of GE 5, pre-heating time of spark plugs (should the GE 5 be provided with), threshold current value, current transformer value.

Moreover, advantageously, the interface functions can be transferred onto a remote device, for example a wireless telecontrol by which it is possible to control the operation of the apparatus also by a user located at relevant distances from the same apparatus.

The invention achieves important advantages.

A first advantage lies in the fact that a system for controlling the switching on/off of a power unit 5 according to the present invention makes it possible to use the latter with a remarkable level of safety for the operators, especially when using it at construction sites wherein the power unit 5 is likely to power more or less, at the same time, a plurality of building machines such as: cranes, hoists, pneumatic hammers, air compressors or, in general, electrical facilities for various applications.

A second advantage lies in the fact that a system for controlling the switching on/off of a power unit 5 for the supply of power to users 2 connected to the load line L, according to the present invention, allows a significant energy saving and a reduction of noise and discharge gas.

This saving is obtained inasmuch as, contrary to the known GEs that have to remain in operation also under a condition of no-energy-demand by the users 2, a GE provided with a control system according to the present invention remains switched on and, thus, consumes fuel, exclusively upon a request by the users 2 or, however, for a period of time slightly longer, and remains instead in the off state when there is no request.

A further advantage consists in that the diesel engines for GEs have a cooling system at constant energy, that is, draw always the same amount of thermal energy from the engine, regardless of how much energy the same engine is producing. This stems from the fact that both the cooling fan and the pump for the circulation of the refrigerating liquid are connected to the engine by the same kinematic chain.

The cooling system is obviously dimensioned to take out the thermal energy that the engine produces at 100% of its rated power. Accordingly, when the delivered power goes below 30-40% of the rated power, the engine is unable to reach the optimal operating temperature, with consequent:
inefficient combustion of the injected fuel;
leak of lubricating oil through the pistons rings;
scaling formation in the combustion chamber and on the injectors.

Thus, the use of a control system according to the present invention extends the service life of engines as well as the intervals between service operations.

The invention has been described with reference to a preferred embodiment thereof, but it understood that equivalent modifications could be made without departing from the scope of the protection granted to the present industrial patent.

1-20. (canceled)

21. Apparatus for controlling the switching on/off of a power unit (5) for power supply power to users (2) connected to a load line (L), characterized in that it comprises: a first monitoring unit (3) of the line (L) for the switching on/off of the power unit (5); a line disconnector (6) applied to the line (L) and operated by the first monitoring unit (3); a second monitoring unit (1) for monitoring any request of energy to the GE (5) by the users (2) when the GE (5) is out of operation, by means of the flow on line (L) of an eddy current (C1) downstream of the disconnector (6) and measuring the variation of impedance on the line (L) following any demand of energy, the second monitoring unit (1) being connected to said first monitoring unit (3), to deliver a signal of switching-on to unit (3) to habilitate the supply of power to the users (2); one or more current detectors (4) connected to said line (L) upstream of said disconnector (6) for continually monitoring the demand of energy on line (L), said detectors (4) being connected to said first monitoring unit (3) of generator (5) to switch off the power unit (5) in the absence of any request of energy for an uninterrupted preset time (T1).

22. Apparatus according to claim 21, wherein said users (2) comprise operating machines located a distance away from the power unit (5).

23. Apparatus according to claim 21, further comprising a supply unit (11) connected to said monitoring unit (1).

24. Apparatus according to claim 21 wherein said detectors (4) are current transformers.

25. Apparatus according to claim 21 wherein said power unit (5) is a generator coupled with an engine having the following characteristics:
three-phase systems (operating range of 233-480 V);
single-phase systems (operating range of 110-240 V);
frequency of 50 and 60 Hz.

26. Apparatus according to claim 21 wherein said power unit (5) also comprises a system for pre-heating spark plugs.

27. Apparatus according to claim 21 wherein said system for pre-heating spark plugs is monitored by the first monitoring unit (3) by means of a first timed relay (R1).

28. Apparatus according to claim 21 wherein said power unit (5) also comprises at least one device for the protection of the generator.

29. Apparatus according to claim 21, said apparatus being fed at low tension.

30. Apparatus according to claim 21 wherein said current detectors (4) are connected in single-phase configuration.

31. Apparatus according to claim 21 wherein said current detectors (4), are connected in three-phase configuration.

32. Apparatus according to claim 21 wherein said current detectors (4) are connected with devices which include current shunts.

33. Apparatus according to claim 21, further comprising a second pilot relay (R2) connected with said line disconnector (6).

34. Apparatus according to claim 21, further comprising a third pilot relay (R3) for piloting the switching on/off of the power unit (5).

35. Apparatus according to claim 21 wherein said relays can pilot signals in direct current.

36. Apparatus according to claim 21 wherein said relays can pilot signals in alternate current.

37. Apparatus according to claim 21, comprising a control interface comprising:
a front panel (7);
at least one on/off key (8) and a key for access to control menu (9); and
a plurality of visual indicators (10) for indicating the operating state of the apparatus.

38. Apparatus according to claim 37, wherein said front panel (7) comprises a remote control device.

39. Apparatus according to claim 37, wherein said front panel (7) is located in proximity of said generator (5).

40. Apparatus according to claim 37, wherein said visual indicators (10) are LEDs.
